(19) United States
(12) Patent Application Publication
(10) Pub. No.: US 2016/0281666 A1
(43) Pub. Date: Sep. 29, 2016

(54) CRYOGENIC PUMP HAVING VENTED PLUNGER

(71) Applicant: Caterpillar Inc., Peoria, IL (US)

(72) Inventor: Dana R. COLDREN, Secor, IL (US)

(73) Assignee: Caterpillar Inc., Peoria, IL (US)

(21) Appl. No.: 14/669,560

(22) Filed: Mar. 26, 2015

(51) Int. Cl. F02M 59/10

(52) U.S. Cl. CPC F02M 59/10

(57) ABSTRACT

A cryogenic pump is disclosed for use with a fuel system having a tank. The cryogenic pump may have a barrel, and a plunger configured to reciprocate within the barrel. The pump may also have an inlet configured to connect the tank to the barrel at a front side of the plunger, and an outlet connected to the barrel at the front side of the plunger. The pump may further have a vent line configured to extend from the barrel at a back side of the plunger to a location outside of the tank.

### TECHNICAL FIELD

The present disclosure relates generally to a pump and, more particularly, to a cryogenic pump having a vented high-pressure plunger.

### BACKGROUND

Gaseous fuel powered engines are common in many applications. For example, the engine of a locomotive can be powered by natural gas (or another gaseous fuel) alone or in combination with another liquid or gaseous fuel (e.g., diesel fuel). Natural gas may be more abundant and, therefore, less expensive than other liquid fuels. In addition, natural gas may burn cleaner in some applications, and produce less greenhouse gas.

Natural gas, when used in a mobile application, may be stored in a liquid state onboard the associated machine. This may require the natural gas to be stored at cold temperatures, typically about −100 to −162° C. The liquefied natural gas is then drawn from the tank by gravity and/or by a boost pump, and directed to a high-pressure pump. The high-pressure pump further increases a pressure of the fuel and directs the fuel to the machine's engine. In some applications, the liquid fuel may be gasified prior to injection into the engine and/or mixed with diesel fuel (or another fuel) before combustion.

One problem associated with pumps operating at cryogenic temperatures involves flash boiling of the natural gas due to low pressures observed during retracting strokes of the pump's pistons. In order to avoid such low pressures, and thereby avoid flash boiling of the natural gas, typical cryogenic pump systems either incorporate large-diameter slow-moving pistons located at the bottom of a fuel tank to minimize pressure, or the systems include an additional boost pump that elevates a pressure of the fluid being directed to the pistons of a separate main pump. Using large diameter pistons results in large, heavy, and expensive pumps that create high-pressure spikes in downstream components (e.g., in accumulators that collect fluid from the pumps). The pressure spikes can be complex and expensive to accommodate (e.g., requiring additional components, such as regulators). Incorporating an additional boost pump can increase a cost of the pumping system and also reduce a reliability of the system.

An exemplary pump is disclosed in U.S. Pat. No. 5,810,570 (the '570 patent) that issued to Nguyen on Sep. 22, 1998. In particular, the pump of the '570 patent includes a spring-loaded suction valve made of magnetic material, and a reciprocating piston located inside a pumping chamber and having a permanent magnet at its head end. The suction valve is positioned such that, when the piston is at or near the top of its stroke, the magnet will tend to pull the suction valve into an open position. As the suction valve is magnetically pulled away from its seat, fresh liquid can easily flow inside the pumping chamber without a pressure loss that could result in flash boiling of the liquid.

While the pump of the '570 patent may be acceptable in some applications, it may be less than optimal. In particular, the suction valve and piston may be expensive to fabricate. In addition, any fluid that does flash boil during the suction stroke of the piston may need to be recovered and the '570 patent does not disclose a way to do this.

The disclosed pump is directed to overcoming one or more of the problems set forth above.

### SUMMARY

In one aspect, the present disclosure is directed to a cryogenic pump for a fuel system having a tank. The cryogenic pump may include a barrel, and a plunger configured to reciprocate within the barrel. The cryogenic pump may also include an inlet configured to connect the tank to the barrel at a front side of the plunger, and an outlet connected to the barrel at the front side of the plunger. The cryogenic pump may further include a vent line configured to extend from the barrel at a back side of the plunger to a location outside of the tank.

In another aspect, the present disclosure is directed to another cryogenic pump for a fuel system having a tank. This cryogenic pump may include a barrel configured to be at least partially submerged inside the tank, and a free-floating plunger reciprocatingly disposed within the barrel. The pump may also include a pushrod configured to extend into the tank to engage a back side of the plunger, and a load plate connected to drive the pushrod. The pump may further include an inlet configured to connect the tank to the barrel at a front side of the plunger, a first check valve disposed in the inlet and movable to allow liquid from the tank into the barrel, an outlet connected to the barrel at the front side of the plunger, and a second check valve disposed in the outlet and movable to allow liquid out of the barrel. The pump may additionally include a vent line configured to extend from the barrel at the back side of the plunger to a location outside of the tank. A pressure differential across the plunger during a retracting stroke of the plunger may be about 0.1-1.7 MPa.

In yet another aspect, the present disclosure is directed to a fuel system for an engine. The fuel system may include a tank configured to hold liquid fuel, a barrel, and a plunger reciprocatingly disposed within the barrel. The fuel system may also include an inlet connecting the tank to the barrel at a front side of the plunger, and an outlet connected to the barrel at the front side of the plunger. The fuel system may further include a vent line configured to extend from the barrel at a back side of the plunger to a low-pressure region of the engine that is located outside of the tank.

In yet another aspect, the present disclosure is directed to a method of fueling an engine. The method may include directing liquid fuel to a front side of a plunger during a retracting stroke, and discharging liquid fuel from the front side of the plunger toward the engine during an extending stroke of the plunger. The method may further include selectively venting gaseous fuel from a back side of the plunger to the engine to create a pressure differential across the plunger during the retracting stroke sufficient alone to lift the plunger.

### BRIEF DESCRIPTION OF THE DRAWING

FIG. 1 is a cross-sectional and diagrammatic illustration of an exemplary disclosed fuel system.

### DETAILED DESCRIPTION

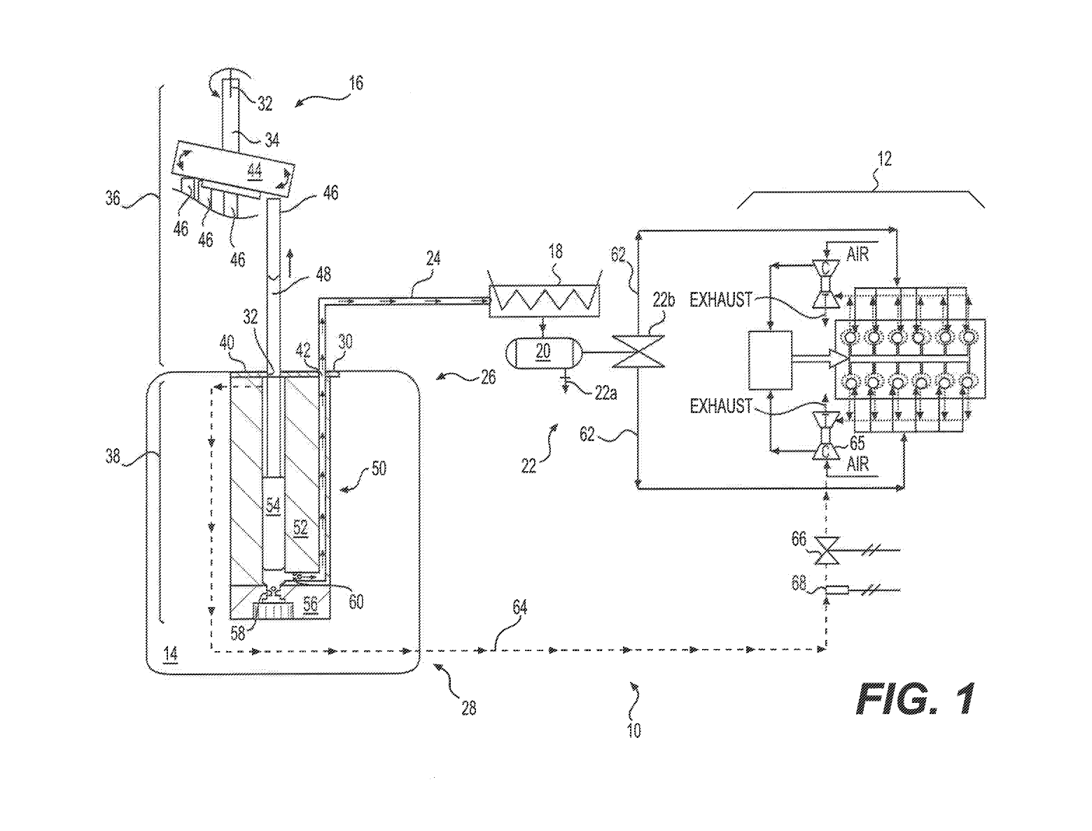

FIG. 1 illustrates an exemplary fuel system 10 having multiple components that cooperate to provide a gasified fuel (e.g., natural gas) to an engine 12 in a regulated manner. These components may include, among other things, a fuel tank (“tank”) 14, a pump 16, a vaporizer 18, a high-pressure accumulator (“accumulator”) 20, and one or more pressure reducing devices 22 (e.g., a vent 22a and a regulator 22b). Liquid fuel (e.g., liquefied natural gas—LNG) may be stored in tank 14, and pump 16 may draw in and pressurize the liquid fuel from tank 14. The pressurized liquid fuel may be directed via a passage 24 to vaporizer 18, which may then heat and thereby gasify the fuel. Accumulator 20 may be located downstream of vaporizer 18 and configured to collect and store gaseous fuel for future use by engine 12. Pressure reducing devices 22 may selectively reduce a pressure of the gaseous fuel to a desired pressure before passing the gaseous fuel to engine 12. It should be noted that the gaseous fuel may be provided alone to engine 12 or together with another fuel (e.g., a liquid fuel, such as diesel).

Tank 14 may be a cryogenic tank configured to hold the natural gas in its liquefied state. In some embodiments, tank 14 has multiple walls separated from each other by an air gap. In other embodiments, an insulating layer may be disposed between the walls. The air gap and/or insulating layer may function to maintain a temperature of the natural gas below its boiling temperature of about −165° C. It is contemplated that tank 14 may be provided with conventional features for handling liquefied natural gas (LNG), for example chillers, circulators, ventilators, etc., as desired.

Tank 14 may be generally cylindrical, having a top 26 and a bottom 28. Top 26 may include an opening 30 that is generally aligned with a central axis 32 of symmetry. Bottom 28 may be closed.

Pump 16 may be at least partially submerged inside of tank 14, for example inside a centralized socket formed in tank 14. Pump 16 may be connected at a base end to tank 14 at top 26, and hang a distance into tank 14. By being connected to tank 14 at only one end, pump 16 may be allowed to expand and contract somewhat due to normal thermal loading without inducing stresses in tank 14 that could damage tank 14. Engine 12, an electric motor (not shown), or another power source may be located outside of tank 14, and connected to drive pump 16 via a mechanical input 34. In the disclosed embodiment, mechanical input 34 is a shaft. In other exemplary embodiments, however, mechanical input 34 could be a gear train, if desired. in any of these arrangements, an output rotation of the power source may induce a corresponding input rotation of mechanical input 34.

Pump 16 may be generally cylindrical and divided into two ends. For example, pump 16 may be divided into a warm or input end 36, into which mechanical input 34 extends, and a cold or output end 38. Warm end 36 may be fixedly mounted to tank 14 at top 26, for example by way of a manifold 40, and cold end 38 may extend from manifold 40 into tank 14. In this configuration, the rotation of mechanical input 34 may function to generate a high-pressure fuel discharge at cold end 38. The high-pressure fuel discharge may be directed back up to warm end 36 via a passage 42 to exit tank 14 at opening 30. In most applications, pump 16 will be mounted and used in the orientation shown in FIG. 1 (i.e., with cold end 38 being located gravitationally lowest).

Pump 16 may be an axial piston type of pump. In particular, mechanical input 34 may be rotatably supported within a housing (not shown), and connected at a bottom end to a load plate 44. Load plate 44 may be oriented at an oblique angle relative to axis 32, such that the rotation of mechanical input 32 may be converted into a corresponding undulating motion of load plate 44. A plurality of tappets 46 may slide along a lower face of load plate 44, and a pushrod 48 may be associated with each tappet 46. In this way, the undulating motion of load plate 44 may be transferred through tappets 46 to pushrods 48 and used to pressurize the fluid passing through pump 16. A resilient member (not shown), for example coil spring, may be associated with each pushrod 48 and configured to bias the associated tappet 46 into engagement with load plate 44. Each pushrod 48 may be a single-piece component or, alternatively, be comprised of multiple pieces, as desired. Many different shaft/load plate configurations may be possible, and the oblique angle of load plate 44 may be fixed or variable. In the disclosed embodiment, the oblique angle of load plate 44 is fixed, and a variable output of pump 16 is obtained via speed adjustment of the power source that is driving mechanical input 34 based on a demand from engine 12.

It should be noted that pump 16 could function differently, if desired. For example, load plate 44 could be replaced with a linear actuator, for example a single- or double-acting cylinder, if desired. The cylinder would be connected to or include pushrods 48, and be selectively supplied with or drained of fluid to generate the undulating axial motion described above. Other options may also be available.

Each pushrod 48 may extend through manifold 40 to connect with a corresponding pump mechanism 50. In the disclosed embodiment, five different pump mechanisms 50 are included. It should be noted, however, that pump 16 may have any number of pump mechanisms 50.

Each pump mechanism 50 may include a generally hollow barrel 52 having an open end connected to manifold 40 and an opposing closed end. A lower portion of each pushrod 48 may extend through the open end of a corresponding barrel 52 to engage the back side of a free-floating plunger 54. In this way, an extending movement of pushrod 48 may translate into a downward sliding motion of plunger 54 toward a Bottom-Dead-Center (BDC) position. As will be explained in more detail below, a pressure differential across plunger 54 may help to return plunger 54 to a Top-Dead-Center (TDC) position as pushrod 46 is retracted from barrel 52.

The pressure differential may be created by way of a vent line 64 that extends from the back side of plunger 54 to engine 12. For example, vent line 64 may extend from the hollow interior of barrel 52 at a location adjacent to manifold 40 to a low-pressure region of engine 12. In the disclosed example, the low-pressure region is a location associated with air intake of engine 12. In one embodiment, the location is upstream of a compressor 65 of engine 12. A pressure of fluid entering barrel 52 at a front side of plunger 54 during the retracting stroke of plunger 54 may be about 0.2-1.7 MPa, while a pressure of vent line 64 at the back side of plunger 54 (i.e., of the low-pressure region of engine 12) is about 0-100 kPa. This pressure differential of about 0.1-1.7 MPa may be sufficient to raise plunger 54 within barrel 52 as pushrod 48 retracts from barrel 52. In an alternative embodiment, vent line 64 could connect to the intake of engine 12 at a location downstream of compressor 65, if desired. However, at the downstream location, the pressure differential across plunger 54 would be less, resulting in a smaller operating range of pump 16. It is also contemplated that engine 12 could be naturally aspirated, if desired.

A control valve 66 may be disposed in vent line 64, and a pressure sensor 68 may be located in vent line 64 upstream of control valve 66. In this arrangement, control valve 66 may be selectively energized based on signals from pressure sensor 68 to adjust a restriction of vent line 64 and thereby the pressure differential across plunger 54. Accordingly, the upward motion of plunger 54 may be selectively tuned to accommodate changes in temperature and pressure affecting operation of pump 16.

One or more valve elements that facilitate fluid pumping during the motion of plunger 48 between BDC and TDC positions may be housed within the closed end (e.g., within a head 56) of pumping mechanism 50. These valve element(s) may include, for example, a first check valve 58 that allows fuel from tank 14 to enter barrel 52 during the retracting motion of pushrod 46, and a second check valve 60 that directs high-pressure fluid from barrel 52 to passage 24 during the subsequent extending motion of pushrod 46. The high-pressure discharge from all pump mechanisms 50 may join each other inside manifold 40 for common discharge from pump 16.

Vaporizer 18 (referring back to FIG. 1) may embody any conventional type of fuel heater known in the art. For example, vaporizer 18 may be a heat exchanger, wherein the liquid fuel from pump 16 is directed through vaporizer 18 to absorb heat from another fluid (e.g., from engine exhaust, from ambient air, from engine coolant, etc). This absorbed heat may be sufficient to vaporize the liquid fuel before it is collected inside accumulator 20. It is contemplated, however, that other types of heaters may be used to vaporize the liquid fuel, if desired, such as electric- or fuel-powered heaters.

Accumulator 20 may embody a high-pressure vessel configured to store pressurized natural gas for future use by engine 12. As a pressure of the natural gas from vaporizer 18 exceeds a pressure of accumulator 20, the natural gas may flow into accumulator 20. Because the natural gas therein is compressible, it may act like a spring and compress as more natural gas flows in. When the pressure of the natural gas at an outlet of accumulator 20 drops below the pressure inside of accumulator 20, the compressed natural gas may expand and exit accumulator 20. It is contemplated that accumulator 20 may alternatively embody a membrane/spring-biased or bladder type of accumulator, if desired. Although the collected gaseous fuel, by itself, may be useful in supplying engine 12, the primary purpose of accumulator 20 may be to dampen pressure oscillations in the flows of natural gas as the gas enters and leaves accumulator 20.

Vent 22a and regulator 22b, while used for different purposes, may function in a similar way. Specifically, vent 22a may be configured to selectively allow gaseous fuel to discharge from accumulator 20 to the atmosphere in a controlled manner (i.e., at a controlled pressure and temperature) that does not compromise the integrity of vent 22a. Regulator 22b may similarly allow gaseous fuel to discharge from accumulator 20 in a controlled manner. In contrast to vent 22a, however, regulator 22b may direct the discharging gaseous fuel to engine 12 via one or more supply lines 62. It is contemplated that vent 22a and regulator 22b may control the gaseous fuel to discharge at the same rates and pressures or at different rates and pressures, as desired. It is contemplated that regulator 22b may control the gaseous fuel to discharge at any desired rate and/or pressure (e.g., at a variable rate and/or pressure) demanded by engine 12.

### INDUSTRIAL APPLICABILITY

The disclosed fuel system finds potential application in any mobile (e.g., locomotive) or stationary (e.g., power generation) application having an internal combustion engine. The disclosed fuel system finds particular applicability in cryogenic applications, for example applications having engines that burn LNG fuel. The disclosed fuel system may provide a high-pressure supply of gaseous fuel in a compact, simple, and robust configuration. Operation of pump system 16 will now be explained.

Referring to FIG. 1, when mechanical input 34 is rotated by an external power source, load plate 44 may be driven to undulate in an axial direction. This undulation may result in translational movement of tappets 46 and corresponding movements of pushrods 48. As each pushrod 48 retracts from a corresponding barrel 52, the pressure of the liquid fuel in tank 14 being significantly greater than the pressure at the back side of plunger 54 (i.e., greater than the pressure at the low-pressure region of engine 12 that is communicated with the back side of plunger 54) may cause liquid fuel to enter barrel 52 and push plunger 54 upward. That is, the pressure differential created across plunger 54 via fuel supply to and venting of plunger 54 may be sufficient, alone, to lift plunger 54 to its retracted position. As pushrod 48 extends back into barrel 52, pushrod 48 may force plunger 54 back downward. The downward movement of plunger 48 may push the liquid fuel from barrel 52 at an elevated pressure. The high-pressure fuel may flow through passage 24 to vaporizer 18, where the fuel is vaporized, before being collected in accumulator 20. The collected gaseous fuel may then be regulated into engine 12.

Because a low-pressure region may not be generated at the front side of plunger 54 during the retracting plunger movement (i.e., because the pressure may be higher at the front side of plunger 54 than at the back side), the fuel entering barrel 52 may be inhibited from flash boiling. This may result in improved efficiency of pump 16. In addition, any leakage around plunger 54 within barrel 52, generally in the form of vapor, may be consumed by engine 12. In fact, any energy contained within this vapor may be utilized to power engine 12, thus improving the efficiency of engine 12. And by removing warm vapor from fuel tank 14 (i.e., via vent line 64) and not returning the heat of the vapor to tank 14, fuel may be held within tank 14 for a longer time before a pressure in the tank needs to be relieved.

It will be apparent to those skilled in the art that various modifications and variations can be made to the pump of the present disclosure. Other embodiments of the pump will be apparent to those skilled in the art from consideration of the specification and practice of the pump disclosed herein. It is intended that the specification and examples be considered as exemplary only, with a true scope being indicated by the following claims and their equivalents.

What is claimed is:

1. A cryogenic pump for a fuel system having a tank, comprising:
a barrel;
a plunger configured to reciprocate within the barrel;
an inlet configured to connect the tank to the barrel at a front side of the plunger;
an outlet configured to connect the barrel at the front side of the plunger; and
a vent line configured to extend from the barrel at a back side of the plunger to a location outside of the tank.

2. The cryogenic pump of claim 1, wherein the barrel is configured to be at least partially submerged inside the tank during operation of the cryogenic pump.

3. The cryogenic pump of claim 2, wherein the plunger is free-floating within the barrel.

4. The cryogenic pump of claim 3, further including:
a pushrod configured to extend into the tank and engage the back side of the plunger; and
a load plate configured to reciprocatingly drive the pushrod.

5. The cryogenic pump of claim 2, further including:
a first check valve disposed in the inlet and configured to allow liquid from the tank into the barrel; and
a second check valve disposed in the outlet and configured to allow liquid out of the barrel.

6. The cryogenic pump of claim 2, wherein:
a pressure at the front side of the plunger during a retracting stroke of the plunger is about 0.2-1.7 MPa; and
a pressure at the back side of the plunger during the retracting stroke of the plunger is about 0-100 kPa.

7. The cryogenic pump of claim 2, wherein a pressure differential across the plunger during a retracting stroke of the plunger is about 0.1-1.7 MPa.

8. A cryogenic pump for a fuel system having a tank, comprising:
a barrel configured to be at least partially submerged inside the tank;
a free-floating plunger reciprocatingly disposed within the barrel;
a pushrod configured to extend into the tank and engage a back side of the plunger;
a load plate connected to drive the pushrod;
an inlet configured to connect the tank to the barrel at a front side of the plunger;
a first check valve disposed in the inlet and movable to allow liquid from the tank into the barrel;
an outlet connected to the barrel at the front side of the plunger;
a second check valve disposed in the outlet and movable to allow liquid out of the barrel; and
a vent line configured to extend from the barrel at the back side of the plunger to a location outside of the tank,
wherein a pressure differential across the plunger during a retracting stroke of the plunger is about 0.1-1.7 MPa.

9. A fuel system for an engine, comprising:
a tank configured to hold liquid fuel;
a barrel;
a plunger reciprocatingly disposed in the barrel;
an inlet connecting the tank to the barrel at a front side of the plunger;
an outlet connected to the barrel at the front side of the plunger; and
a vent line configured to extend from the barrel at a back side of the plunger to a low-pressure region of the engine that is located outside of the tank.

10. The fuel system of claim 9, wherein the vent line is configured to extend to an air inlet of the engine.

11. The fuel system of claim 10, wherein:
the engine includes a compressor; and
the vent line is configured to extend to an air inlet location upstream of the compressor.

12. The fuel system of claim 10, wherein:
the engine includes a compressor; and
the vent line is configured to extend to an air inlet location downstream of the compressor.

13. The fuel system of claim 9, wherein the barrel is disposed inside the tank and at least partially submerged during operation of the engine.

14. The fuel system of claim 13, wherein the plunger is free-floating in the barrel.

15. The fuel system of claim 14, further including:
a pushrod extending into the tank to engage the back side of the plunger; and
a load plate connected to reciprocatingly drive the pushrod.

16. The fuel system of claim 15, further including:
a first check valve disposed in the inlet and movable to allow liquid fuel into the barrel; and
a second check valve disposed in the outlet and movable to allow liquid fuel out of the barrel,
wherein the vent line is configured to vent gaseous fuel from the back side of the plunger into the engine.

17. The fuel system of claim 9, wherein:
a pressure of the tank is about 0.2-1.7 MPa; and
a pressure at the compressor is about 0-100 kPa.

18. The fuel system of claim 9, wherein a pressure differential across the plunger is about 0.1-1.7 MPa during operation of the engine.

19. A method of fueling an engine, comprising:
directing liquid fuel to a front side of a plunger during a retracting stroke;
discharging liquid fuel from the front side of the plunger toward the engine during an extending stroke of the plunger; and
selectively venting gaseous fuel from a back side of the plunger to the engine to create a pressure differential across the plunger during the retracting stroke sufficient alone to lift the plunger.

20. The method of claim 19, wherein selectively venting gaseous fuel includes venting gaseous fuel to an air intake of the engine.
